(19) United States
(12) Patent Application Publication
(10) Pub. No.: US 2010/0210861 A1
(43) Pub. Date: Aug. 19, 2010

(54) PROCESS AND SYSTEMS FOR INTEGRATED DEACIDIFICATION OF VEGETABLE OIL OR ANIMAL FATS AND CONVERSION OF FREE FATTY ACIDS INTO MONOHYDRIC ALCOHOL ESTERS

(75) Inventors: Richard R. Woods, Irvine, CA (US); Vahik Krikorian, La Canada, CA (US)

Correspondence Address: Joseph M Kobzeff, P.O.Box 50502, Irvine, CA, 92619, US

(73) Assignee: PRIMAFUEL, INC., Signal Hill, CA (US)

(21) Appl. No.: 12/708,301

(22) Filed: Feb. 18, 2010

Related U.S. Application Data
(60) Provisional application No. 61/153,612, filed on Feb. 18, 2009.

(51) Int. Cl. C11B 3/10; B01D 15/08; B01J 8/04

(52) U.S. Cl. 554/192; 422/187

(57) ABSTRACT

Methods and systems for producing both purified triacylglycerides and fatty acid-monohydric alcohol esters from a feed material comprising vegetable oil or animal fat with elevated levels of free fatty acids is disclosed. Various embodiments include adsorptive techniques.

### CROSS-REFERENCE TO RELATED APPLICATIONS

This application claims the benefit under 35 USC §119(e) of U.S. Provisional Application No. 61/153,612 , filed on Feb. 18, 2009; the disclosure of which is hereby expressly incorporated by reference in its entirety and is hereby expressly made a portion of this application.

### FIELD OF THE INVENTION

[Methods for the purification of vegetable or animal oils/fats (collectively, “oil”) and in particular embodiments, to crude vegetable or animal oils/fats, including those with elevated levels of free fatty acids are provided. In some preferred embodiments, the source of the vegetable oil can be oil recovered from a corn ethanol facility. In some preferred embodiments, purified vegetable or animal oil/fat can be produced. In some preferred embodiments, free fatty acids or soaps present in a starting material can be converted to fatty acid monohydric alcohol esters.

### BACKGROUND OF THE INVENTION

There is an extensive biofuels industry developing in the U.S. and internationally. In the U.S. this industry includes manufacturing ethanol from corn through fermentation. Two different types of corn ethanol facilities are the dry grind facilities and the wet mill facilities. The dry grind facilities grind the corn into flour; convert the starches into sugars through enzymatic means; ferment the sugars into ethanol; remove the ethanol through evaporation which leaves a mixture of watery biomass known as whole stillage. This whole stillage is processed by a centrifuge into wet cake of distiller's grains (solids) and thin stillage (water with solubles and fine solids). The thin stillage is further processed in a series of evaporators to remove the water, which is fed back into the process, and solids, which are added to the wet cake and further processed and dried into animal feed, known as wet distiller's grain or dry distiller's grain depending on the water content remaining in the solids.

Corn used in these facilities typically has an oil content of about 4% on a dry mass basis. The oil passes through the process and some of it can be extracted from the thin stillage before it is processed into animal feed. Typically, this is achieved by passing the thin stillage or syrup between two of the evaporators through a centrifuge and isolating the lighter oil phase from the heavier liquid/solid phase. The corn oil that is recovered is crude and can have a composition of 70-85% triacylglycerides, 5-20% free fatty acids (“FFAs”), ˜3% monoglycerides and diglycerides, and ˜1-5% other minor components. The corn oil with such high levels of FFAs has very low market value due to the difficulties in its refining. As the FFA content increases, conventional processes such as caustic refining and physical refining become less efficient. In some facilities, FFA contents of about 2% are viewed as uneconomical to process. In caustic refining a strong base is added to the oil to neutralize the FFAs. As a result, the FFAs are converted into soap and due to their lower densities they are segregated and separated from the rest of the oil. They can be removed either by settling and consequent skimming or they can be removed via centrifugation. On the other hand, in physical refining a steam distillation is employed where the crude oil is subjected to super saturated steam to solubilize FFAs and extract at reduced pressures after condensation. While both of these processes are satisfactory with low FFA concentrations, higher FFA content of the crude oil can lead to increased losses of the triacylglyceride product. This is mainly due to entrapment of triacylglycerides in either the emulsions formed in the caustic refining or carried over with the steam in physical refining.

The high FFA corn oil extracted from a dry-grind ethanol facility can be sold at a relatively low value off-specification crude product as supplemental animal feed, or processed into alternative fuels such as biodiesel. Each of these products has only a fraction of the market value of food grade corn oil.

Similar problems can be present with other sources of vegetable or animal oils/fats. Elevated levels of free fatty acids lead to higher losses and higher costs for a range of oil/fats, including, but not limited to, palm, palm kernel, cocoa, soy bean, cotton seed, canola, sunflower, rapeseed, fish, tallow, lard, peanut, olive, grapeseed, walnut, flaxseed, as well as other vegetable and animal sourced oils/fats. As described above, these problems are particularly pronounced when high free fatty acid levels are present, either naturally, or due to previous processing, storage, or use of the oil or its vegetable/animal form. As a result, a method of purifying the triacylglycerides and utilizing the free fatty acids is highly desirable.

### SUMMARY OF THE INVENTION

A method of preparing oils of higher purity and esters of monohydric alcohols and fatty acids is desirable.

Accordingly, in a first aspect, a process is provided for simultaneously producing a purified vegetable oil and a material rich in mono-alkyl esters, the process comprising: sequentially contacting a stationary phase with a feedstock comprising a triacylglyceride and a free fatty acid, and a reactant stream comprising monohydric alcohol, wherein a catalyst is present during at least a portion of the contacting of the stationary phase with the monohydric alcohol; collecting a first stream comprising triacylglyceride depleted of free fatty acids; and collecting a second stream containing a fatty acid ester of a monohydric alcohol.

In an embodiment of the first aspect, at least a portion of the stationary phase is at least a portion of the catalyst.

In an embodiment of the first aspect, the first stream comprises free fatty acids at a concentration of less than about 2% (wt.).

In an embodiment of the first aspect, the first stream comprises free fatty acids at a concentration of less than about 1% (wt.).

In an embodiment of the first aspect, the first stream comprises free fatty acids at a concentration of less than about 0.7% (wt.).

In an embodiment of the first aspect, the first stream comprises free fatty acids at a concentration of less than about 0.5% (wt.).

In an embodiment of the first aspect, the first stream comprises free fatty acids at a concentration of less than about 0.3% (wt.).

In an embodiment of the first aspect, the second stream comprises fatty acid monoesters at a first weight concentration and free fatty acids at a second weight concentration, the first concentration being greater than the second concentration.

In an embodiment of the first aspect, the first stream comprises free fatty acids at a third weight concentration, and the triacylglyceride feedstock comprises free fatty acids at a fourth weight concentration, the third concentration being less than 40% of the fourth concentration.

An embodiment of the first aspect, the amount of free fatty acids present in the feedstock is present at a first mass, the amount of free fatty acids present in the first stream is present at a second mass, and the amount of free fatty acids present in the second stream is present at a third mass, the first mass being greater than the sum of the second mass and third mass.

In an embodiment of the first aspect, the amount of free fatty acids present in the feedstock is present at a first mass, the amount of free fatty acids present in the first stream is present at a second mass, and the amount of free fatty acids present in the second stream is present at a third mass, the first mass being greater than the sum of the second mass and third mass, and the ratio of the sum of the second mass and third mass to the first mass is less than about 1 to 2.

In an embodiment of the first aspect, the amount of free fatty acids present in the feedstock is present at a first mass, the amount of free fatty acids present in the first stream is present at a second mass, and the amount of free fatty acids present in the second stream is present at a third mass, the first mass being greater than the sum of the second mass and third mass, and the ratio of the sum of the second mass and third mass to the first mass is less than about 1 to 4.

In an embodiment of the first aspect, the amount of free fatty acids present in the feedstock is present at a first mass, the amount of free fatty acids present in the first stream is present at a second mass, and the amount of free fatty acids present in the second stream is present at a third mass, the first mass being greater than the sum of the second mass and third mass, and the ratio of the sum of the second mass and third mass to the first mass is less than about 1 to 8.

In an embodiment of the first aspect, the amount of free fatty acids present in the feedstock is present at a first mass, the amount of free fatty acids present in the first stream is present at a second mass, and the amount of free fatty acids present in the second stream is present at a third mass, the first mass being greater than the sum of the second mass and third mass, and the ratio of the sum of the second mass and third mass to the first mass is less than about 1 to 10.

In an embodiment of the first aspect, the amount of free fatty acids present in the feedstock is present at a first mass, the amount of free fatty acids present in the first stream is present at a second mass, and the amount of free fatty acids present in the second stream is present at a third mass, the first mass being greater than the sum of the second mass and third mass, and the ration of the sum of the second mass and third mass to the first mass is less than about 1 to 15.

In an embodiment of the first aspect, the amount of free fatty acids present in the feedstock is present at a first mass, the amount of free fatty acids present in the first stream is present at a second mass, and the amount of free fatty acids present in the second stream is present at a third mass, the first mass being greater than the sum of the second mass and third mass, and the ratio of the sum of the second mass and third mass to the first mass is less than about 1 to 20.

In an embodiment of the first aspect, the amount of free fatty acids present in the feedstock is present at a first mass, the amount of free fatty acids present in the first stream is present at a second mass, and the amount of free fatty acids present in the second stream is present at a third mass, the first mass being greater than the sum of the second mass and third mass, and the ratio of the sum of the second mass and third mass to the first mass is less than about 1 to 30.

In an embodiment of the first aspect, the stationary phase comprises an ion exchange resin.

In an embodiment of the first aspect, the stationary phase comprises an ion exchange resin and the catalyst is acidic.

In an embodiment of the first aspect, the stationary phase comprises an ion exchange resin, the catalyst is acidic, and the acidic catalyst is a mineral acid.

In an embodiment of the first aspect, the stationary phase comprises an ion exchange resin and the chromatographic bed comprises a cationic exchange resin.

In an embodiment of the first aspect, the stationary phase comprises an ion exchange resin and the chromatographic bed comprises a strongly cationic resin.

In an embodiment of the first aspect, the stationary phase comprises an ion exchange resin and the chromatographic bed comprises a weakly acidic resin.

In an embodiment of the first aspect, the stationary phase comprises an ion exchange resin, the reactant stream further comprises an acid, and ions of free fatty acids are adsorbed to the chromatographic resin during contacting with the feedstock, and are desorbed when contacted with the reactant stream comprising alcohol and acid.

In an embodiment of the first aspect, the stationary phase comprises an ion exchange resin, the reactant stream further comprises an acid, wherein the acid comprises a mineral acid, and ions of free fatty acids are adsorbed to the chromatographic resin during contacting with the feedstock, and are desorbed when contacted with the reactant stream comprising alcohol and acid.

In an embodiment of the first aspect, the stationary phase comprises an ion exchange resin, the reactant stream further comprises an acid, and ions of free fatty acids are adsorbed to the chromatographic resin during contacting with the feedstock, and are desorbed when contacted with the reactant stream comprising alcohol and acid, and the acidic alcohol comprises methanol.

In an embodiment of the first aspect, the stationary phase comprises an ion exchange resin, the reactant stream further comprises an acid, and ions of free fatty acids are adsorbed to the chromatographic resin during contacting with the feedstock, and are desorbed when contacted with the reactant stream comprising alcohol and acid, and monohydric alcohol comprises ethanol.

In an embodiment of the first aspect, the stationary phase is present in a simulated moving bed chromatography system.

In an embodiment of the first aspect, the stationary phase comprises a reverse phase stationary phase that has larger affinity with respect to the triglycerides as compared to the feedstock.

In an embodiment of the first aspect, the stationary phase comprises a reverse phase stationary phase that has larger affinity with respect to the triglycerides as compared to the feedstock, wherein the feedstock comprises an eluent added at the same or a different point from another portion of the feedstock.

In an embodiment of the first aspect, the stationary phase comprises a reverse phase stationary phase that has a larger affinity with respect to the triglycerides as compared to one or more of the non-triglyceride materials in the feedstock and in some embodiments, the greater affinity is for triglycerides as compared to more than about 90% (wt.) or 95% (wt), or 98% (wt), or 99% (wt) or 99.9% (wt.) of the non-triglyceride materials in the feed and eluent.

In an embodiment of the first aspect, the stationary phase comprises a reverse phase stationary phase that has a larger affinity with respect to the triglycerides as compared to one or more of the non-triglyceride materials in the feedstock and in some embodiments, the greater affinity is for triglycerides as compared to more than about 90% (wt.) or 95% (wt), or 98% (wt), or 99% (wt) or 99.9% (wt.) of the non-triglyceride materials in the feed and eluent, and wherein the feedstock comprises an eluent added at the same or a different point form another portion of the feedstock.

In an embodiment of the first aspect, the stationary phase comprises a reverse phase stationary phase that has larger affinity with respect to the triglycerides, and the feedstock further comprises homogenous catalyst with excess alcohol.

In an embodiment of the first aspect, the stationary phase comprises a reverse phase stationary phase that has larger affinity with respect to the triglycerides, and the reactant stream further comprises an agent to increase its polarity.

In a second aspect, a system is provided for simultaneously producing a purified vegetable oil, and a material rich in fatty acid monohydrate alcohol esters from an animal or vegetable fat/oil, the system comprising a separation bed system having a first zone and a second zone, wherein the first zone utilizes an adsorption process, configured to separate a fatty acid from an triacylglyceride, and the second zone utilizes a combined desorption-reaction process, configured to catalytically convert at least a portion of the fatty acid present into a fatty acid monohydric alcohol ester.

In a second aspect, a system is provided for simultaneously producing a purified vegetable oil, and a material rich in fatty acid monohydrate alcohol esters from an animal or vegetable fat/oil, the system comprising a separation bed system comprising a simulated moving bed chromatography system, the separation bed system having a first zone and a second zone, wherein the first zone utilizes an adsorption process, configured to separate a fatty acid from an triacylglyceride, and the second zone utilizes a combined desorption-reaction process, configured to catalytically convert at least a portion of the fatty acid present into a fatty acid monohydric alcohol ester.

In a second aspect, a system is provided for simultaneously producing a purified vegetable oil, and a material rich in fatty acid monohydrate alcohol esters from an animal or vegetable fat/oil, the system comprising a separation bed system, the separation bed system further comprising a weakly acidic cationic exchange resin, and the separation bed system having a first zone and a second zone, wherein the first zone utilizes an adsorption process configured to separate a fatty acid from an triacylglyceride, and the second zone utilizes a combined desorption-reaction process, configured to catalytically convert at least a portion of the fatty acid present into a fatty acid monohydric alcohol ester.

In a second aspect, a system is provided for simultaneously producing a purified vegetable oil, and a material rich in fatty acid monohydrate alcohol esters from an animal or vegetable fat/oil, the system comprising a separation bed system, the separation bed system further comprising a strongly acidic cationic exchange resin, and the separation bed system having a first zone and a second zone, wherein the first zone utilizes an adsorption process configured to separate a fatty acid from an triacylglyceride, and the second zone utilizes a combined desorption-reaction process, configured to catalytically convert at least a portion of the fatty acid present into a fatty acid monohydric alcohol ester.

### BRIEF DESCRIPTION OF THE DRAWINGS

FIG. 1 is a flow diagram of a system for adsorptive processes, which can include in-situ regenerative bed (IRB), simulated moving bed (SMB), and catalytic reaction bed (CRB) operations.

FIG. 2 is a diagram of a system for adsorptive processes where the reaction section is combined with a separation section such as combining a CRB with an IRB or a SMB.

FIG. 3 is a graph of the concentration of free fatty acids exiting an adsorption column with DOWEX 2030 resin at a mobile phase flowrate of 1 bed volume per hour.

FIG. 4 is a graph of the concentration of free fatty acids exiting an adsorption column with DOWEX 2030 resin at a mobile phase flowrate of 3.3 bed volume per hour.

FIG. 5 is a graph of the concentration of free fatty acids exiting an adsorption column with a vinylpyridine resin.

### DETAILED DESCRIPTION OF THE PREFERRED EMBODIMENT

### Definitions

Unless characterized otherwise, technical and scientific terms used herein have the same meaning as commonly understood by one of ordinary skill in the art.

The term “adsorption process” as used herein is a broad term, and is to be given its ordinary and customary meaning to a person of ordinary skill in the art (and is not to be limited to a special or customized meaning), and refers without limitation to separation processes and combined separation-reaction processes, which include adsorption as a part of the methods being employed. Included are techniques such as in-situ regenerative bed adsorption; chromatography, including simulated moving bed chromatography; and catalyzed reactive bed adsorption.

The term “chromatographic separation” as used herein is a broad term, and is to be given its ordinary and customary meaning to a person of ordinary skill in the art (and is not to be limited to a special or customized meaning), and refers without limitation to rate-based separation of chemical species over a stationary solid phase chromatographic stationary phase by differential partitioning of the species between the stationary phase and a mobile phase. Differential partitioning can occur during the contacting of a process feed stream with a stationary phase, upon contacting a stationary phase having adsorbed species, or both. The effect can be different species exiting the system at different times, or with SMB, at different points of the system.

The term “stationary phase” as used herein is a broad term, and is to be given its ordinary and customary meaning to a person of ordinary skill in the art (and is not to be limited to a special or customized meaning), and refers without limitation to a solid phase sorbent of an adsorption process, including the bed or column material in chromatography, the adsorbent material in ion exchange, the adsorbent material in CRB, and the solid phase adsorptive material in adsorbers. Related terms include resin, adsorbent, chromatographic bed material and chromatographic sorbent.” The stationary phase material can be utilized in IRB, CRB, and SMB systems.

The term “resin” as used herein is a broad term, and is to be given its ordinary and customary meaning to a person of ordinary skill in the art (and is not to be limited to a special or customized meaning), and refers without limitation to stationary phase material, generally, and can include natural and synthetic materials, such as polymeric, zeolites, alumina, silica, and zirconia materials, whether functionalized, derivatized, whether modified or unmodified. In some usages herein, the meaning can be limited to synthetic materials, such as synthetic ion exchange resin or synthetic adsorption resin, with the context indicating a broad or narrow meaning. In some usages herein, the meaning can be limited to zeolites, alumina, silica, or zirconia based substrates, with the context indicating a broad or narrow meaning In some usages herein, the meaning can be naturally occurring or chemically or physically surface functionalized substrates.

The term “in-situ regenerative bed system” as used herein is a broad term, and is to be given its ordinary and customary meaning to a person of ordinary skill in the art (and is not to be limited to a special or customized meaning), and refers without limitation to adsorptive separation systems where particular species are adsorbed from a material onto a stationary phase, and remain on the stationary phase until treated with a material causing the desorption of the adsorbed species. In some cases, the adsorbed species can be adsorbed from a mobile phase flowing through stationary phase, and the adsorbed species can be desorbed from the stationary phase into a mobile phase. Frequently, a bed is used to adsorb particular species until it is saturated, at which point the saturated bed is removed from the process stream and treated to cause desorption of the adsorbed species and regeneration of the bed. Frequently, the bed will remove virtually all of the species being adsorbed from the mobile phase until the stationary phase is saturated, or until removed from service. In cases where the bed becomes saturated, saturation can be detected by “breakthrough” (a sudden increase in concentration) of the species being adsorbed in the mobile phase exiting the bed.

The term “simulated moving bed chromatography” as used herein is a broad term, and is to be given its ordinary and customary meaning to a person of ordinary skill in the art (and is not to be limited to a special or customized meaning), and refers without limitation to forms of chromatographic separation or other adsorptive processes where, for example, through a valving arrangement, movement of solid phase in a direction opposite of the mobile phase is simulated or accomplished. Frequently, such systems allow for continuous feed streams to be used with resulting continuous outlet streams. The adsorption that takes place in this form of chromatography frequently is a partitioning of adsorbed species from the process feed between a stationary phase and a mobile phase, with adsorbed species being shifted to create portions of mobile phase having higher and lower concentration. Frequently, a chromatographic separation that does not utilize simulated moving bed technology requires interruption of the process feed containing the species to be separated and the timed capture of the various product streams.

The term “catalyzed reactive bed” as used herein is a broad term, and is to be given its ordinary and customary meaning to a person of ordinary skill in the art (and is not to be limited to a special or customized meaning), and refers without limitation to systems utilizing a stationary phase capable of adsorbing at least a portion of a chemical species present that undergoes a selective catalytic reaction that takes place in concert with adsorptive and/or desorptive phenomena. CRB systems can be operated in a fashion similar to chromatographic, IRB, or SMB systems, including where a continuous feed of a mobile phase comprising reagents is supplied to one or more stationary phase beds with adsorbed species, with valving or other means to simulate or achieve movement of the beds through the reactive step and continuous removal of product stream(s) at particular points. CRB systems can be operated as a single bed desorptive system or a multi-bed desorptive system, wherein a reactive mobile phase flows through the bed(s) resulting in selective catalytic reaction taking place in concert with adsorptive and/or desorptive phenomena along with, in some cases, repositioning of the beds. Frequently, favorable effects on both reaction kinetics and reaction equilibrium can be achieved due to the continuous removal of reaction products from the reaction zone as well as, in those systems utilizing a simulated moving bed arrangement, a countercurrent movement of stationary phase, with associated reagents, to the mobile phase with its associated reagents. In some embodiments, a constituent of the stationary phase can act as a catalyst in the system. In some embodiments, a catalyst can be supplied with the mobile phase. In some embodiments both a constituent of the mobile phase and a constituent of the stationary phase can act as catalysts.

### Description

The following description and examples illustrate some exemplary embodiments of the disclosed invention in detail. Those of skill in the art will recognize that there are numerous variations and modifications of this invention that are encompassed by its scope. Accordingly, the description of a certain exemplary embodiment should not be deemed to limit the scope of the present invention.

Direct transesterification of high free fatty acid (FFA) animal or vegetable oil/fat is difficult due to the occurrence of saponification with resulting formation of soaps under conditions suitable for transesterification of the triacylglycerides. As a result, yields can be reduced. One approach to avoid these problems involves production of fatty acid monohydric alcohol esters from animal or vegetable oils/fats containing high levels of FFAs in a two step process. First, the FFAs can be converted into biodiesel using an acid catalyst (homogeneous or heterogeneous). This reaction can be highly selective towards conversion of FFAs into fatty acid monohydric alcohol esters and water, with little or no conversion of the triacylglycerides into fatty acid monohydric alcohol esters. Second, the triacylglycerides can be converted to monohydric alcohol esters. The second step can be facilitated by neutralization of the process stream and removal of water prior to conversion of the triacylglycerides. The neutralization and water removal adds complexity and difficulty that results in further complications of the overall process.

Another approach can utilize adsorptive processes in combination with reactive processes, such as by combining catalyzed reactive bed (CRB), in situ reactive bed (IRB), and simulated moving bed (SMB) systems, such as to increase the reactant concentration at the point where the reaction occurs, catalyze the reaction, and/or separate the final products. Bulk reaction of FFAs with the alcohol in acid esterification of high FFA oils can be slow and require high ratios of alcohol to FFA, in some instances, about 20 to 1 molar ratio of alcohol to FFA or higher. While not wishing to be bound by theory, this slow rate may be due at least in part to the presence of large amounts of triacylglyceride with the FFAs, which hinder the constructive collision of FFAs with alcohol molecules. Increasing the concentration of FFAs at the point of reaction can increase the rate of the reaction due to the increase in the constructive collisions between FFAs and alcohol. In addition, some stationary phase materials can also serve to remove at least a portion of any water present or produced by reaction or prevent it from entering the mobile phase. The removal/isolation of water can favorably shift the equilibrium of the reaction and/or more favorably maintain catalyst activity. Systems which separate the free fatty acids from the triacylglycerides prior to conversion of the free fatty acids to esters can, in addition to exhibiting higher reaction rates during the esterification, can also provide a separate oil stream comprising triacylglycerides, and a separate monoalkyl ester stream suitable for purposes including biodiesel use.

In some embodiments, the total amount of free fatty acids/soaps can be reduced as compared to the amount of free fatty acids/soaps in the feed material. In some embodiments, the combined amount of free fatty acids/soaps in the product streams is less than about 80% (wt.) of the amount in the feedstream, or less than about 70% (wt.) of the amount in the feed stream, or less than about 60% (wt.) of the amount in the feed stream, or less than about 50% (wt.) of the amount in the feed stream, or less than about 40% (wt.) of the amount in the feed stream, or less than about 30% (wt.) of the amount in the feedstream, or less than about 20% (wt.) of the amount in the feedstream, or less than about 10% (wt.) of the amount in the feedstream, as determined by comparing the amount of free fatty acids/soaps in the product streams on a kg/hr basis to the amount of free fatty acids/soaps in the feedstream on a kg/hr basis, or as determined by comparing the amount of free fatty acids/soaps in an aliquot of combined product material with the amount of free fatty acids/soaps in the aliquot of feed material that produced the combined product material.

Feed Material

Oil material of various forms can be utilized, such as crude, refined, recycled, heat treated, partially processed, partially refined, off-spec, or rejected animal or vegetable oil or fat. Various feed materials can have different types and amounts of materials which are not triacylglycerides, such as various types or amounts of free fatty acids, soaps, partial glycerides (such as monoacylglycerides, diacylglycerides), phospholipids, lysophospholipids, glycerol, pigments or color bodies (collectively “chromophores”), sterols and derivatives (e.g. squalenes, cholesterol, including hydrogenated and non-hydrogenated forms), wax esters, gums, peroxides, anisidine reactive compounds, proteins, carbohydrates, as well as other materials that may be present due to their presence in the oil source, introduced during processing, handling, or use of the oil or fat (such as by an addition or reaction or a combination of these).

In some embodiments, the pH of the process feed can be adjusted prior to or in conjunction with an adsorption step. Such pH adjustment can include increasing the pH, lowering the pH, or stabilizing the pH, such as with a buffer.

In some embodiments, the process feed can be preprocessed, such as to react or to remove particular compounds, such as phospholipids, waxes, chromophores or residual water. The removal of waxes and some other undesirable high molecular weight components can be achieved by processes such as cooling followed by centrifugation or filtration using a membrane based separation system or a size exclusion filtration system. The phospholipids can frequently be removed by using aqueous phosphoric acid as a good solvent and then skimmed off the surface or centrifuging the mixture. The phospholipids and the waxes can potentially interact with the functional moieties on the surface of the stationary phase and/or plug their pores and foul the bed. However, in some embodiments, the potential problems can be controlled, such as by selection of stationary phase, mobile phase, temperature, or chemical environment, allowing for sustained operation with a significant level of these contaminants.

In some embodiments, the process feed can have varying amounts of free fatty acids, such as values of about 0.5% (wt.) to about 2% (wt.) or about 1.5% (wt.) to about 6% (wt.), or about 5% (wt.) to about 10% (wt.), or about 8% (wt.) to about 16% (wt.), or higher such as up to about 20 or 25% (wt.).

In some embodiments, the process feed can include one or more solvents, such as a monohydric alcohol (such as methanol, ethanol, 1-propanol, 2-propanol, 1-butanol, 2-butanol, or other monohydric alcohols having more than four carbons), a dihydric alcohol, a carbonyl (such as acetone, MEK, 2-propanone, or other higher carbon acetones or ketones), hydrocarbons (such as pentane, hexane, heptane, octane, benzene, toluene, etc.), or nitriles or halocarbons, as well as combinations of these.

In a preferred embodiment, the adsorption of free fatty acids from triacylglycerides can be performed on an intermediate stream from a vegetable oil extraction plant. Suitable intermediate streams include micella (e.g. solvent extracted vegetable oil with the solvent present, such as hexane and oil, heptane and oil, alcohol and oil, etc.). Operation on such intermediate streams can allow purification of the triacylglyceride without an additional desolventization step necessary beyond what would have already been done.

Process Steps

In one embodiment, a separation system, such as an SMB or IRB system can utilize anion exchange resin to adsorb fatty acids from a feed stream comprising an animal or vegetable oil/fat and free fatty acids or soaps. Suitable anion exchange resins include strong anion exchange resins and weak anion exchange resins. The anion exchange resin can then be treated with a liquid phase comprising an acidic alcohol to react the free fatty acids present to alcohol esters and remove them from the bed.

In one embodiment, an SMB or IRB system can utilize a non-ionic adsorbent to adsorb fatty acids from a stream comprising an animal or vegetable oil/fat and free fatty acids or soaps. Not ionic adsorbent can include polymeric adsorbents, zeolites, silicas, zirconias, etc. including neutral, acidic, and basic forms. The adsorbent can then be treated with a liquid phase comprising an acidic alcohol in a reactive step to react at least a portion of the free fatty acids present to alcohol esters and remove them from the bed.

In one embodiment, an SMB or IRB system can utilize a weak cationic resin in the stationary phase to remove free fatty acids from a feedstream comprising an animal or vegetable oil/fat and free fatty acids, with the free fatty acids moving in the same simulated direction as the stationary phase, as compared to the inlet. A product stream having reduced free fatty acid content can be produced at one outlet. The solid phase, enriched with free fatty acids can undergo a reactive step, such as with acidic alcohol, to convert at least a portion of the free fatty acids present to alcohol esters and remove them from the bed.

In one embodiment, an SMB or IRB system can utilize a strong cationic stationary phase to remove free fatty acids from a feed stream comprising an animal or vegetable oil/fat and free fatty acids, with the free fatty acids moving in the same simulated direction as the stationary phase, as compared to the inlet. A product stream having reduced free fatty acid content can be produced at one outlet. The solid phase, enriched with free fatty acids can undergo a reactive step to convert at least a portion of the free fatty acids present to fatty acid esters. In one embodiment, the reactive step can include treatment with acidic alcohol. In one embodiment, the reactive step can include addition of an acidic alcohol. In one embodiment, the reactive step can include the addition of an acid to the fatty acid enriched stationary phase and an alcohol can be supplied as a part of the feed stream comprising animal or vegetable oil/fat and free fatty acids. In one embodiment, the reactive step can include addition of an alcohol to the fatty acid enriched stationary phase and an acid can be supplied as a part of the feed stream comprising animal or vegetable oil/fat and free fatty acids. In one embodiment, the reactive step can include addition of an alcohol to the fatty acid enriched stationary phase and a base can be supplied as a part of the feed stream comprising animal or vegetable oil/fat and free fatty acids.

Soaps, salts of fatty acids and metal ions, also can be similarly adsorbed with the metal ion displaced from the fatty acid combining with, in some cases, the hydroxide ion or anionic salt displaced from the resin. In some cases, the soap can take up a hydrogen ion from a resin, and in some cases the soap or a resulting free fatty acid can be adsorbed to a stationary phase and operate in a similar fashion as one free fatty acids are fed to the system. In some embodiments, a feed stream having soaps present can be neutralized by acid present in the mobile phase and turning the IRB or SMB system. In some embodiments, acid can be added to the feed material to convert soaps to free fatty acids.

In some embodiments, a reactive step can be operated as a catalyzed reactive bed (CRB), with a reagent stream entering at one point in the CRB system and a product stream comprising fatty acid alkyl esters leaving at another point. In some embodiments, the product stream can have very low residual free fatty acids, such as less than about 2% (wt.), or less than 0.5% (wt), or less than a measurable or detectable amount. In some embodiments, the reagent stream can comprise an alcohol suitable for esterification with a fatty acid; an acid suitable for use as a catalyst in an esterification reaction. In some embodiments, at least a portion of the stationary phase can act as a catalyst in a reaction between fatty acids and a component of the reagent stream. Suitable alcohols for esterification with a fatty acid include those suitable for production of biodiesel products, such as those having 1-4 carbons, such as methanol, ethanol, 1-propanol, 2-propanol, 1-butanol, 2-butanol, 2-methyl 2-propanol, 2-methyl-1-propanol, etc., including mixtures, but in some embodiments can include alcohols having more than four carbons and preferably only one hydroxyl group, such as butanols, pentanols, hexanols, heptanols, octanols, etc. In various embodiments, the reagent stream can further comprise a nonpolar solvent, such as a hydrocarbon, including hexane, heptane, octane, etc.

Mobile Phase

In some embodiments, a mobile phase comprising a monohydric alcohol, such as an alcohol suitable for esterification with a fatty acid moiety to produce a material suitable for use in a biodiesel material, can be used. In some embodiments, the concentration of monohydric alcohol in a mobile phase can be more than about 10% (wt.), more than about 20% (wt.), more than about 30% (wt.), more than about 40% (wt.), more than about 50% (wt.), more than about 60% (wt.), more than about 70% (wt.), more than about 80% (wt.), more than about 90% (wt.), or more than about 95% (wt.). In some embodiments, a mobile phase can comprise a triacylglyceride. In some embodiments, triacylglycerides can be present in a mobile phase at more than about 10% (wt.), more than about 20% (wt.), more than about 30% (wt.), more than about 40% (wt.), more than about 50% (wt.), more than about 60% (wt.), more than about 70% (wt.), more than about 80% (wt.), more than about 90% (wt.), or more than about 95% (wt.). In some embodiments, at least a portion of a mobile phase can be introduced with a process feed. In some embodiments, a portion of a mobile phase can be introduced with a process feed and a portion can be recycled through an IRB, SMB, or CRB operation.

In some embodiments, a mobile phase can comprise an acid, such as a mineral acid or an organic acid. In some embodiments, the acid can act as an acidifying, or pH lowering agent, such as can neutralize or acidify various species present or to shift an equilibrium between species present, such as species provided by the process feed, reacted from the process feed, and/or the stationary phase. In some embodiments, an acid can act as a catalyst for a reaction, such as an esterification reaction. In some embodiments, more than one acid can be utilized, and in some embodiments, the acid can act as an acidifying or pH lowering agent and catalyze one or more reactions. Suitable acids include hydrochloric, nitric, sulfuric, citric, acetic, propanoic, hydrobromic, hydroiodic, perchloric, etc.

In some embodiments, a mobile phase comprising a supercritical material or near supercritical material (collectively “supercritical”) can be utilized, such as supercritical CO2, supercritical propane, supercritical ethane, or supercritical methane. In some embodiments, a supercritical mobile phase can include a material to modify the solubility of species in the supercritical fluid, such as by modifying the polarity of the solvent system. In some embodiments, a supercritical mobile phase can include a material to modify the acidic properties of the supercritical fluid. Suitable modifiers include those that increase the polarity or acidity of the solvent system, such as ethanol, acetonitrile, acetone, methanol, water, etc.

In some embodiments, a mobile phase used for a portion of a process which includes an SMB or an IRB operation, can be different from a mobile phase used for a portion of a process which includes a CRB operation. In some embodiments, a mobile phase used for a portion of a process which includes an SMB or an IRB operation, can be the same as a mobile phase used for a portion of a process which includes a CRB operation. In some embodiments, the mobile phase from a portion of a process comprising an SMB or an IRB operation can flow directly or indirectly to a portion of the process comprising a CRB operation, or vice versa.

In a preferred embodiment, the adsorption of free fatty acids from triacylglyceride, such as in an SMB, IRB, or CRB, can occur in an environment with little or no added solvent (i.e., neat animal or vegetable oil/fat of varying purity). Operation without added solvent can result in production of a triacylglyceride product with reduced need for further desolventization.

Solvation Aid

In some embodiments, a solvation aid can be included in a feed stream or in a mobile phase to increase the solubility of soaps, salts, base, and/or water in the feed stream, before, during, or after the adsorption step. Suitable solvation aids include those that increase the solubility of desired species in the feed stream or assist in preventing the formation of a second phase, such as a precipitate, a liquid, or a gas. Solvation aids can include alcohols, such as methanol, ethanol, propanol, isopropanol, butanol, etc.; carbonyl containing compounds, such as acetone and methyl ethyl ketone, acetaldehyde, carboxylic acids, etc.; and surfactants; as well as materials that are less desirable due to their environmental problems, such as hydrocarbons, including hexane, heptane, toluene, etc.; nitrile compounds, including acetonitrile, etc.; halogenated organics, including chloroform, dichloromethane, etc.; and solvent systems including those described by or related to those described by Folch and by Bligh and Dyer for total lipid extraction, as well as solvent systems including combinations of hydrocarbons, alcohols and water, also used for total extraction of lipids.

Stationary Phase—General

In some embodiments, a stationary phase having strong attraction to free fatty acids can be utilized. In some embodiments, a stationary phase having a somewhat weaker attraction to free fatty acids can be used. In some embodiments, desorption of the fatty acid species can be facilitated by conversion of the fatty acid to an ester to change the strength of the attraction. Suitable stationary phases can include ion exchange resins as well as other materials, especially those having highly polar or hydrophilic characteristics. Suitable stationary phase materials include cationic resins (strong or weak), chelating resins, anionic resins (strong or weak), neutral adsorbents (activated carbon, polymeric materials, zeolites, silicas, zirconias, etc., whether in an acid, neutral, or basic state).

Anionic resin can form an ionic bond with the fatty acids. Zeolites and other neutral adsorbents can form van der Waals attractions and hydrogen bonds with the fatty acids. Acidic and basic zeolites and other neutral adsorbents can additionally form acid-base interactions with the soaps and fatty acids present. Additional mechanisms that can be present include size exclusion with resins or zeolites, silicas, zirconias, etc. with increased retention time of for shorter molecules such as FFAs as compared to the larger triacylglycerides. Polar phase resins, including cationic, anionic, and many neutral stationary phases, attract the ionic or polar end of a FFA while non-polar resins, including many functionalized stationary phases, such as those used in reverse phase chromatography, will exclude the polar or ionic end of the FFA, leading to different rates of passage through the system.

Stationary Phase—Cationic Resins

Suitable material for stationary phases for IRB, SMB, and CRB processes include cationic resins, such as weak cationic resins and strong cationic resins. Strong cationic resins include those resins having a strong acidic group covalently to a resin structure. Frequently, the acidic group is a sulfonic acid group. Strong cationic resins include those resins listed in Table 1.

In one embodiment, a cationic resin can be used to separate free fatty acids or soaps from a stream also comprising triacylglycerides. Frequently, cationic resins are porous beads of polystyrene or polydivinylbenzene, functionalized with sulfonic acid groups (strong cationic resin) or carboxylic acid groups (weak cationic resin). Suitable forms for use in a stationary phase include hydrogen, sodium, potassium, lithium, calcium, magnesium as well as combinations of these forms. The density of these functional groups on the surface relate to the capacity of the resin for a given volume or mass of the resin. The pore size and the porosity of the resin can contribute to the mass transfer characteristics of a particular resin and can also contribute to the pressure drop characteristics across the bed.

While in some situations, cationic resins, especially strong cationic resins, can be used to separate positively charged ions from other materials, it has been found that strong cationic resins can also be used to separate neutral free fatty acids and negatively charged free fatty acid salts or soaps from streams comprising triacylglycerides. While not wishing to be bound by theory, a cationic resin or acidic zeolite may form a hydrogen bond or a polar-polar attraction with the stationary phase.

In some embodiments, reaction of the fatty acid with an alcohol to form an ester, reduces the strength of the hydrogen bonding or polar attraction, and allows the ester form of the FFA to desorb and move, or move faster, with the mobile phase.

In some embodiments, strong cationic resins can be incorporated into a stationary phase, including those having catalytic activity. See, e.g., Table 1.

TABLE 1
Strong acid ion exchange resins.

| Resin Material | Supplier |
|---|---|
| Diphonix | Eichrom (Darien, IL) |
| Nafion | DuPont (Wilmington, DE) |
| Mono Plus S100 | Lewatit (Birmingham, NJ) |
| S1467 | Lewatit (Birmingham, NJ) |
| GF-303 | Lewatit (Birmingham, NJ) |
| S100 | Lewatit (Birmingham, NJ) |
| Amberlyst 15 | Rohm & Haas (Reading, PA) |
| Amberlyst BD20 | Rohm & Haas (Reading, PA) |
| Amberlite IR 120 | Rohm & Haas (Reading PA) |
| Dowex-2030 | Dow (Midland, MI) |
| Dowex HCR | Dow (Midland, MI) |
| SK112 | Mitsubishi (Tokyo, Japan) |

Weak cationic resin, which can be utilized as stationary phases include those manufactured by Eichrom, DuPont, Lewatit, Rohm & Haas, Dow, Mitsubishi, and others, and include those shown in Table 2.

TABLE 2
Weak Cationic Resins

| Resin Material | Manufacturer |
|---|---|
| Diaion WK10 | Mitsubishi Chemical Corp. |
| Diaion WK11 | Mitsubishi Chemical Corp. |
| Diaion WK20 | Mitsubishi Chemical Corp. |

Stationary Phase—Chelating Resins

Chelating resins can also be utilized in a manner similar to a strong or a weak cationic resin. Chelating resins can operate by have more than one cation exchanging site in close proximity such that they can act on a single ion. In some embodiments, an amine-diacetic acid group can be utilized in the acid or a salt form. In some embodiments, multiple amine groups can be provided on a functional side chain of the resin. In some embodiments, multiple hydroxyl groups can be positioned near an amine on a functional chain of a resin. Examples of suitable chelating resins include those shown in Table 3 (Products from other companies are also available, such as the companies listed in Table 1).

TABLE 3
Chelating Resins

| Resin Material | Manufacturer |
|---|---|
| Diaion CR 10 | Mitsubishi Chemical Corp. |
| Diaion CR 11 | Mitsubishi Chemical Corp. |
| Diaion CR 20 | Mitsubishi Chemical Corp. |
| CRB 01 | Mitsubishi Chemical Corp. |
| CRB 02 | Mitsubishi Chemical Corp. |

Stationary Phase—Adsorbents

In some embodiments, adsorbents can also be successfully utilized to separate free fatty acids from triacylglycerides. Suitable adsorbents can include activated carbon, impregnated activated carbon (acidic, basic, etc.), neutral adsorption resins, etc. Suitable neutral adsorbents can be polymeric or otherwise. Polymeric adsorbents include those having aromatic characteristics, such as those based on styrene-divinylbenzene, or other characteristics such as those imparted by acrylic or methacrylic materials. Other adsorbents include materials based on silica, alumina, magnesium silicate, glass, hydroxyalkylmethacrylate, hydroxyapatite, agarose, graphite, titania, zirconia, cellulose, zeolite, or other materials utilized in chromatography, including liquid chromatography, flash chromatography, and high-performance liquid chromatography. These materials can be functionalized, such as with nitrile (cyano), amino/amide, alkyl, phenyl, and fluorinated organic groups and can in some embodiments include end capping.

Adsorption of the free fatty acids or soaps can be by polar interactions, hydrophobic interactions, hydrogen bonding, or by other means. In some embodiments, reaction of the fatty acid with an alcohol to form an ester, reducing the strength of the hydrogen bonding, polar attraction, hydrophilic interaction, and allowing the ester form of the FFA desorb and move with the mobile phase.

Stationary Phase—Anionic Ion Exchange Resin

In some embodiments, a strong or weak anionic exchange resin can be utilized to adsorb free fatty acids and/or soaps from the feed stream. A reaction for adsorption of a free fatty acid onto an anion resin in the hydroxide form is:

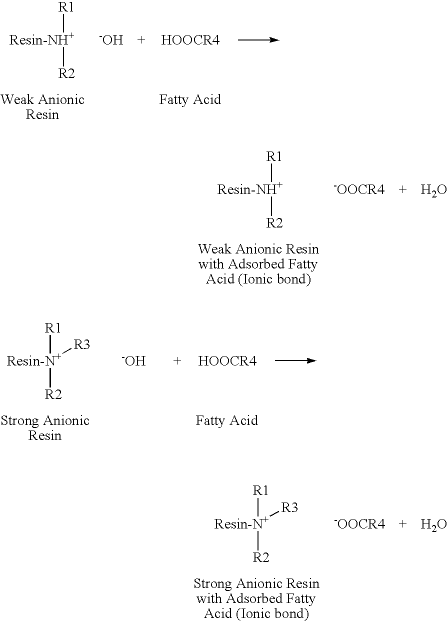

The anion exchange resin can also be in other forms, including chloride, nitrate, etc., in which case the reaction equation would be modified to have the appropriate ion adsorbed to the anionic resin on the left side of the equations and an acid, whether ionized or combined, on the right hand side of the equation.

Suitable anion exchange resins include those having tertiary amine or quaternary ammonium groups attached to a suitable matrix, such as a polystyrene or acrylate/methacrylate polymer, or other suitable material. Suitable anion exchange resins include those shown in Table 4 ((Products from other companies are also available, such as the companies listed in Table 1).

TABLE 4
Anion Resins

| Resin Material | Type | Manufacturer |
|---|---|---|
| Diaion WA10 | Weak | Mitsubishi Chemical Corp. |
| Diaion WA11 | Weak | Mitsubishi Chemical Corp. |
| Diaion WA20 | Weak | Mitsubishi Chemical Corp. |
| Diaion WA21 | Weak | Mitsubishi Chemical Corp. |
| Diaion WA30 | Weak | Mitsubishi Chemical Corp. |
| Diaion SA 10A | Strong | Mitsubishi Chemical Corp. |
| Diaion SA 11A | Strong | Mitsubishi Chemical Corp. |
| Diaion SA 12A | Strong | Mitsubishi Chemical Corp. |
| Diaion SA 20A | Strong | Mitsubishi Chemical Corp. |
| Diaion SA 21A | Strong | Mitsubishi Chemical Corp. |
| Diaion PA 306 | Strong | Mitsubishi Chemical Corp. |
| Diaion PA 308 | Strong | Mitsubishi Chemical Corp. |
| Diaion PQ 312 | Strong | Mitsubishi Chemical Corp. |
| Diaion PA 316 | Strong | Mitsubishi Chemical Corp. |
| Diaion PA 318 | Strong | Mitsubishi Chemical Corp. |
| Diaion PA 406 | Strong | Mitsubishi Chemical Corp |
| Diaion PA 408 | Strong | Mitsubishi Chemical Corp |
| Diaion PA 412 | Strong | Mitsubishi Chemical Corp |
| Diaion PA 416 | Strong | Mitsubishi Chemical Corp |
| Diaion PA 418 | Strong | Mitsubishi Chemical Corp |

Stationary Phase—Zeolites—Acidic

Acidic zeolite materials can also be used in some embodiments as a stationary phase. Generally, acidic zeolite materials can include zeolites which have been modified by the presence of additional ions, such as sodium or potassium, which impart an acidic character to the material.

In operation, free fatty acids/soaps can adsorb to an acidic zeolite material by one or more of hydrophobic/hydrophilic interaction, polar interaction, acid-base interaction, and size exclusion phenomena.

In some embodiments, adjustment of the pH of the feed material or the mobile phase can improve the separation/adsorption, for example, by changing the relative amounts of free fatty acids in the acid form and in an ionized or salt form, or by changing the acidic nature of the adsorbent.

Stationary Phase—Zeolites—Basic

Basic zeolite materials can also be used in some embodiments as a stationary phase. Generally, basic zeolite materials can include zeolites which have been modified by the presence of additional ions, such as cesium or rubidium, which impart a basic character to the material.

In operation, free fatty acids/soaps can adsorb to a basic zeolite material by one or more of hydrophobic/hydrophilic interaction, polar interaction, acid-base interaction, and size exclusion phenomena.

In some embodiments, adjustment of the pH of the feed material or the mobile phase can improve the separation/adsorption by, for example by changing the relative amounts of free fatty acids in the acid form and in an ionized or salt form, or by changing the basic nature of the adsorbent.

Interactions with Other Components of the Feed Material

In some embodiments, compounds other than free fatty acids, soaps, and triacylglycerides can be present in the feed material. These other compounds can be made to separate with a triacylglyceride stream, or a fatty acid stream, collected as a third stream, or partitioned between two or more of these streams.

In some embodiments, other components, such as partial glycerides can be separated with the triacylglycerides, such as by selecting a stationary phase that more preferentially adsorbs the free fatty acids or soaps. In some embodiments the partial glycerides can be collected separate from the triacylglycerides, such as by utilizing a stationary phase that has stronger interactions with the partial glycerides than the triacylglycerides, such as those that have greater hydrogen bonding, smaller pores, or greater hydrophilic interaction. Partial glycerides can then by collected with or separate from the monoalkyl ester material.

Likewise, other compounds can be made to separate with the triacylglycerides or the monoalkyl esters, or separately, based on the selection of the stationary phase and conditions presented by the mobile phase selected.

Esterification Reaction

The adsorbed fatty acids can be reacted to fatty acid esters and eluted from the resin by treatment of the resin with a stream comprising alcohol and/or an alcohol catalyst mixture, depending on the adsorption characteristics of the resin in the solvating power of the stream. Suitable reaction systems include those with an alcohol that is suitable for production of biodiesel and an acid-suitable as a catalyst for catalyzing an esterification reaction between the alcohol and fatty acid. In some embodiments, an alcohol with an acid catalyst is added to the resin or flowed through the resin bed. Suitable alcohols include those suitable for combination with fatty acids to produce biodiesel products, such as monohydric alcohols with 1-4 carbon atoms and mixtures of alcohols, as well as others, as described herein. Suitable acid catalysts include mineral acids and strong acids, such as hydrochloric acid, nitric acid, sulfuric acid, phosphoric acid, perchloric acid, hydroiodic acid, hydrobromic acid, chloric acid, bromic acid, perbromic acid, iodic acid, periodic acid, fluoroantimonic acid, magic acid, carborane superacid, fluorosulfuric acid, triflic acid, and the like. While it is not common to use an acid to regenerate an anionic resin, acids frequently being used to regenerate cationic resins, the combination of a suitable alcohol and acid catalyst has been found to regenerate the anionic resin and simultaneously produce fatty acid esters, such as those suitable for biodiesel. The reason or mechanism for this combination of results is not known, but without being bound by theory, such a response may be due to the conversion of the adsorbed acid group to an ester, with the result of rendering the fatty acid non-ionic, less ionic, or less polar and therefore less strongly held by the anionic resin. The following chemical equation shows the net reaction for a strong anionic resin; a similar equation can be written for a weak anionic resin:

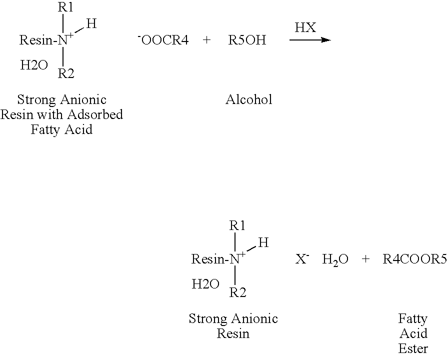

In some embodiments, when an anion resin or basic adsorbent (zeolite, etc.) is regenerated with an acid, as described above, it can be necessary to regenerate the anionic resin two to the adsorption of the acid counter ions, such as sulfate, chloride, etc. to the resin. Such regeneration can be performed, for example, by rinsing the bed with a basic solution, such as a base and water or a base in alcohol, after desorption of the fatty acids. Such a rinse can be performed with the bed in the same position as for desorbing/reacting or in a separate position. Suitable bases include KOH, NaOH, as well as others used for regenerating an ion exchange resins.

In one embodiment, a cationic exchange resin can be utilized to adsorb free fatty acids and/or soaps from the feed stream and desorbed at the next stage. While note wishing to be bound by theory, the interaction for adsorption of a free fatty acid onto a cationic resin in the acidic form may be described as follows:

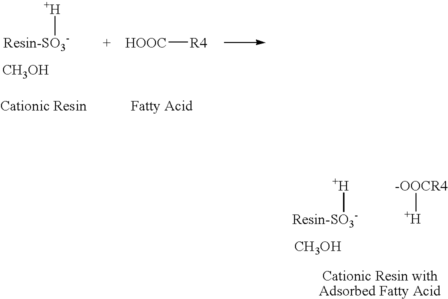

The oil containing high levels of FFAs can be brought in contact with the highly acidic cationic bed. The FFAs can be adsorbed on the surface until a breakthrough point is reached, or until before a breakthrough point is reached. The resin bed is then regenerated by flushing it with a desorbent that can be reactive or non reactive. In embodiments where the desorbent is non reactive, such as with desorbents including aliphatic hydrocarbons or low molecular weight ketones, the FFAs can be desorbed from the bed and transferred into the desorbent, which the desorbent may be removed and recycled. In the case the desorbent solution reacts with the FFAs adsorbed on the resin bed, the bed can acts as a catalyst, or the catalyst can be part of the desorbent solution, or the adsorbent can act as a catalyst. After the reaction, due to conversion of the carboxylic acid groups with chemical moieties that have lower affinity to the bed than the FFAs they will be desorbed and exit the system downstream through the desorbent phase.

In another embodiment the oil is passed through the resin bed in a chromatographic setup, where the elution of the FFAs (i.e. moieties that have stronger affinity with the bed) is hindered and therefore the retention times are longer. The longer retention times or slower velocity of the FFA downstream are taken advantage of by cycling the bed upstream effectively creating a negative or upstream movement of the FFA in the series of beds.

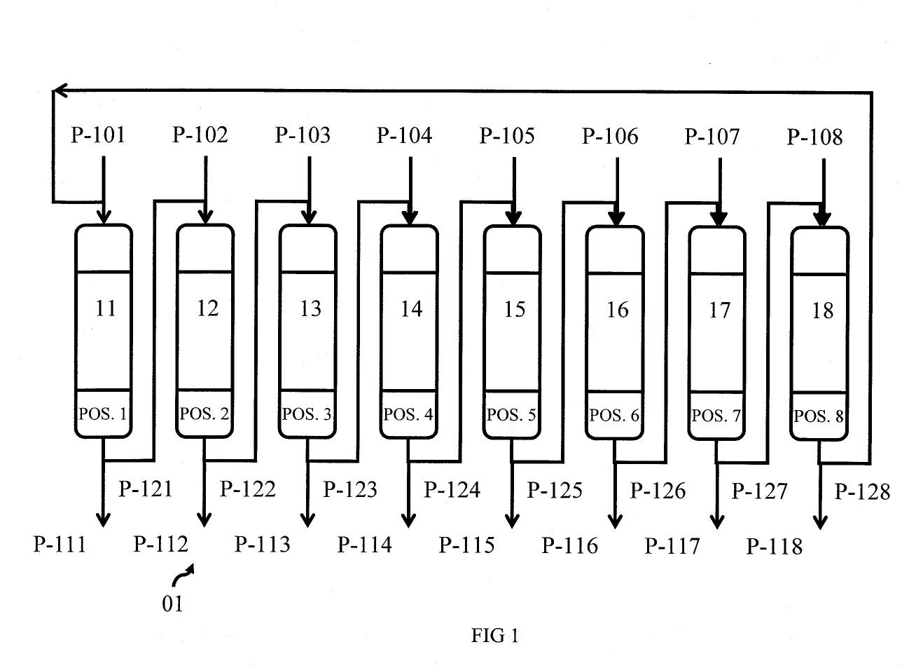

FIG. 1 illustrates an adsorption system 01 including a series of adsorption beds connected in series. This illustration shows eight beds or positions, identified as Position 1 to Position 8 respectively, however fewer beds, such as low as three, or more beds, including up to 24 or more, can be utilized, as desired. Each position can have a feed stream, P-101 to P-108 respectively, an exit stream, P-111 to 118 respectively, and a by-pass stream, P-121 to P-128 respectively. In some embodiments, a number of beds can be present at a position, such as arranged in series, parallel, or a combination of series and parallel. Each inlet stream and outlet stream can be equipped with a valve system, with automatic or other actuation, that controls what specific fluid is allowed to flow into and out of the position, with automatic or other actuation. In some embodiments, valves for different beds can be combined into a common system, such as with a turntable system, or valves within a bed can be combined into a common system. In various embodiments, the valve systems can utilize various types of valves or valving devices, and different types can be utilized at various points in the overall system. Exemplary valves and valving devices that can be used include on/off, shut off valves, three way valves, multiple way valves, sliding valves, pinch valves, rotating valves, blinds, and devices that result in the movement or blockage of a port, however other devices providing a shut off or rerouting function can also be used. During processing the process position of beds or sets of beds can change, such as through actuation of valve systems or movement of the beds. Such changing of the process position of the beds allows, for example, the bed receiving fresh feed material to change as beds move through the feed position, and allow beds to discharge product or other materials as they move through the position for discharge of product or other material.

Operation of an In-Situ Regenerative Bed System

In one embodiment, the system illustrated in FIG. 1 can be utilized as an in-situ regenerative bed (IRB) system in which a process feed including triacylglycerides and free fatty acids is introduced at Position 3, and flows in series from Position 3 to Position 8 and the resin material 11 and 12 located at Positions 1 and 2 is regenerated. Process fluid enters Position 3 through connection P-103 and flows through resin material 13 in Position 3. The process stream exits Position 3 and flows to Position 4 through connection P-123, where it flows through resin material 14, exits and continues to flow through the resin materials in Positions 5, 6, 7, and 8. After flowing through the resin material 18 in Position 8, the process fluid exits through connection P-118. As the process fluid moves through the resin in Positions 3-8, free fatty acids are adsorbed onto the surface of the resin and the process fluid is purified. During operation, resin materials 11 and 12 in Positions 1 and 2 are washed with working fluid(s) to regenerate the resin's adsorbent capacity. This is achieved, for example, by flowing the working fluid through connection P-101, through resin 11, out connection P-121, in connection P-102, through resin 12, and out connection P-112. Once the resin in Position 1 is regenerated and before the resin in Position 8 is saturated with FFAs, the positions of the beds are changed, by valve systems or otherwise, to shift beds to the next lower numbered position, and the bed(s) at Position 1 to Position 8. The effect is to move the regenerated resin material to Position 8, partially regenerated resin to Position 1, resin 18 to Position 7, resin 17 to Position 6, resin 16 to Position 5, resin 15 to Position 4, resin 14 to Position 3, and resin 13 to Position 2 so that it can be regenerated. The resin material does not need to be physically moved, but its processing position can be changed by adjusting the inlet and outlet connections at each position with, for example, its valve system, or in some systems, the actual resin can be moved by, for example, repositioning beds.

Operation of a Simulated Moving Bed System

In one embodiment, the system illustrated in FIG. 1 can be utilized as a simulated moving bed (SMB) system in which the automatic valve sequencing is adjusted on a timed or sensor response basis to simulate the reverse movement of the resin material opposite of the primary fluid flow. As the fluid tends to flow from left to right or from Position 1 to Position 2 and on in series to Position 8, the beds are virtually moved in the opposite direction or from Position 8 to Position 7 and so on, eventually the resin material in Position 1 is moved to Position 8 to complete the cycle. One difference between an SMB and an IRB system is that in an SMB system a working fluid known acts as a mobile phase is also used. The mobile phase needs to have sufficient solvation power for the process fluid compounds. The resin materials can be selected based on their interaction with one or more of the compounds in the process feed as well as their interaction with components of the mobile phase. The interaction can be related to things such as molecular size, ionic characteristics, polarity, van der Waals attraction, affinity for water, hydrogen bonding, or other chemical/physical characteristics.

In an embodiment of an SMB system, the mobile phase can be fed into Position 1 through connection P-101, passes through stationary phase material 11, exits out through by-pass connection P-121 to Position 2 exiting out through by-pass connection P-122 to Position 3 and onward to Position 4, Position 5, Position 6, Position 7 and Position 8. Process fluid is introduced into the system in the middle of the positions such as through connection P-105 and mixes with the mobile phase and passes through the chromatographic bed material in Position 5 exiting through by-pass connection P-125 to Position 6 and onward to Position 7, and Position 8. As the process fluid contacts the chromatographic bed material, fatty acids are at least partially adsorbed to the resin which effectively decreases their flow velocity in comparison to triacylglycerides and the mobile phase. As the mobile phase and process stream passes from Position 5 to Position 6 to Position 7 to Position 8, a solution of higher purity triacylglyceride in mobile phase enters Position 8. This higher purity triacylglyceride and mobile phase solution exits the system through connection P-128. As this is occurring fatty acids continue to flow toward Positions 6, 7 and 8, but prior to the triacylglycerides exiting through connection P-128, the automatic valve system is adjusted to effectively move the resin beds to the left or countercurrent to the bulk liquid flow. Effectively the resin material 18 in Position 8 is moved to Position 7, and resin material 17 in Position 7 is moved to Position 6, and resin material 16 in Position 6 is moved to Position 5, and resin material 15 in Position 5 is moved to Position 4, and resin material 14 in Position 4 is moved to Position 3, and resin material 13 in Position 3 is moved to Position 2, resin material 12 in Position 2 to Position 1, and finally resin material 11 in Position 1 to Position 8. This sequence is defined as a bed transition sequence. Effectively this switching of the beds creates a pulsed reverse flow of all the solution in the beds. By adjusting the timing of the sequencing with respect to the rate of process fluid flow and the relative attraction of fatty acids and triacylglycerides to the resin, the SMB is operated such that triacylglycerides and the mobile phase have a net movement from left to right and fatty acids have a net movement from right to left. SMB systems are frequently cycled at a relatively high rate such that the process flow direction and the reverse bed sequencing in some embodiments establish a standing concentration wave across the system, or relatively stable positions of increased concentration of various feed stream components.

When the bed switching occurs the resin 15 which is moved to Position 4 has a mixture of fatty acids and triacylglycerides in mobile phase. As the mobile phase flows through this resin, the triacylglyceride continues to move more quickly to the right with the mobile phase than the fatty acids, due to the greater interaction with the resin. Similarly, the resin material 13 in Position 3 and material 12 in Position 2 are moved to the left resulting in a mobile phase solution enriched in fatty acids and depleted of other process feed components. Once the fatty acids have reached Position 2, a portion of the mobile phase solution enriched in fatty acids and depleted of triacylglycerides can be removed from exit connection P-112, while allowing a portion of the mobile phase solution to continue to Position 3. With proper sequencing, and with only fresh mobile phase flowing into the system at connection P-101, the resin material 11 in Position 1 is relatively free of fatty acids when it is switched to Position 8, which prevents fatty acids from significantly contaminating the triacylglyceride exiting connection 118.

Many variations of the SMB system are conceivable. One example is a three Position system in which by-pass connection P-122 is closed and fresh mobile phase is introduced into feed connection P-103. Another example is where the process fluid is fed in pulses rather than continuously. Yet another example is where fewer positions are located downstream of the process feed and more positions are located upstream or visa-versa. Optimization of the SMB system can also include the cycling of various feed and exit valves within the automatic valve system during a bed transition sequence.

In another embodiment the stationary phase in the SMB system can be a reverse phase resin in which it preferentially adsorbs the triacylglycerides allowing them to move with the stationary phase (effectively upstream toward position 1) and the FFA to proceed downstream toward Position 8. The stationary phase in this case can be functionalized, for example, by C6 to C20 chains.

Operation of a Catalyzed Reactive Bed

In one embodiment, the system illustrated in FIG. 1 can be used as a catalyzed reactive bed system (CRB), where at least a portion of the stationary phase material, a compound carried by the mobile phase, or a combination of these acts as a catalyst to catalyze a reaction between compounds in the process fluid and mobile phase. In one embodiment of a CRB, the feed reactants can be fed through a stationary phase, such as a resin bed, where at least a portion of the stationary phase is catalytically active to a reaction, such as an esterification reaction, and the reaction products flow out of the bed. In another embodiment, a material with catalytic activity in a desired reaction, such as a homogeneous catalyst for esterification reactions, can be present in the mobile phase and/or the feed material. In some embodiments, a homogeneous catalyst can be added to the feed material, to the mobile phase upstream of the catalytic reactive bed, added separately to the catalytic reactive bed, or added by some combination of these methods to the system. In some embodiments, a stationary phase, at least a portion of which having catalytic activity can be used in conjunction with the addition of a homogeneous catalyst to the system. In this embodiment the Positions 3 to 8 are used as reactions zones and Position 1 and 2 are regeneration zones. The feed material and catalyst are introduced into Position 3 through connection P-103 and continue to flow from downstream through connection P-123 to Position 4, than through Positions 5, 6, 7, and 8 until the reaction is completed and the reaction products exit through connection 118. As the catalytic activity of the resin decrease the valving system is adjusted to effectively move the stationary phase of Position 3 to Position 2 where it is regenerated or refreshed by passing a regeneration solution through connection P-101 through P-121 to Position 2 and out through connection P-112. The regenerated stationary phase in Position 1 is switched to Position 8 when the Position 3 is moved to Position 2.

In general the IRB, SMB and the CRB systems are very useful in separating, purifying and reacting specific compounds. Selection of the appropriate stationary phase material with respect to the specific compounds and time sequencing of the valves provides process flexibilities.

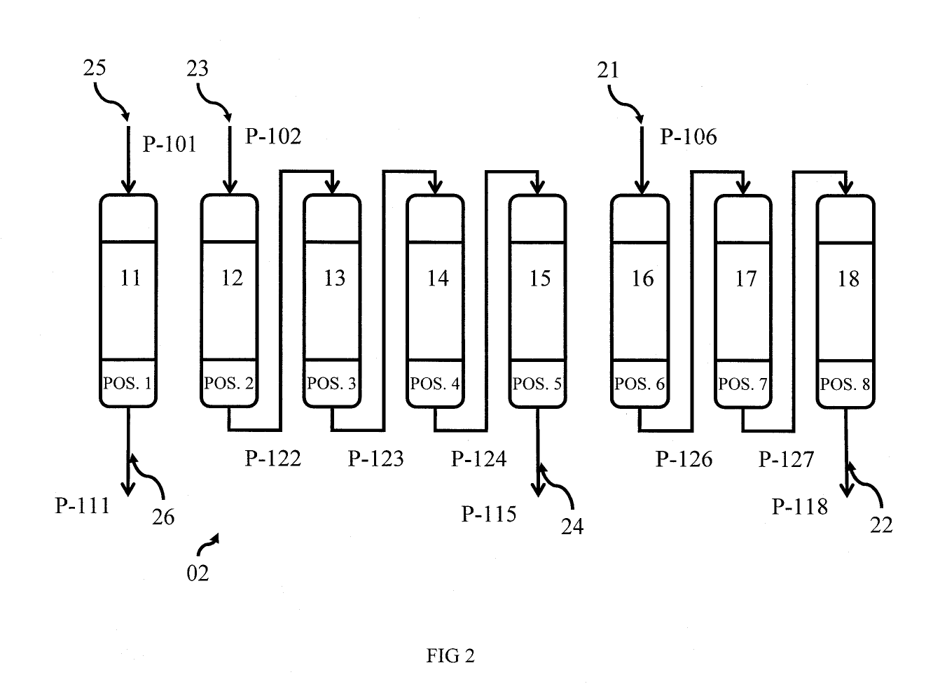

In some embodiments, as illustrated in FIG. 2, a CRB system can be integrated with an SMB or an IRB system to simultaneously produce a purified triacylglyceride material and a fatty acid monohydric alcohol ester.

In an embodiment utilizing an innovative process the functionalities of the IRB, CRB and SMB are integrated to achieve surprising results in conversion efficiency, selectivity and purification in an integrated process. The initial process of this embodiment is an IRB section of the integrated process. A feed material 21 comprising an animal or vegetable fat/oil having an elevated level of free fatty acids can be fed to the system at Position 6 through connection P-106 and flows through resin material 16; passes through connection P-126 to Position 7 and through resin material 17; passes through connection P-127 to Position 8 and through resin material 18; and finally exiting the system through connection P-118. As the feed material 21 passes through the resin materials 16, 17, and 18 FFAs adsorb onto or interact with the stationary phase surfaces and are separated from the triacylglyceride, which might or might not also interact with the stationary phase, to produce a higher purity crude triacylglyceride material 22 which exits the process. As the feed material passes through stationary phase positions 6-8, the free fatty acids and triacylglycerides separate from each other. In this embodiment the stationary phase is described as a strong acid resin which has an attraction to the polar end of the FFA, but other resins or stationary phase could be used with similar results. As in an SMB-type and/or IRB-type process, depending on the configuration, stationary phase is sequenced upstream and the mobile phase effectively flows downstream. The beds are sequenced to the left for additional processing and/or regeneration, following completion of a specific function. The bed that was in optional Position 1, which has been regenerated, is cycled into the Position 8 position.

The beds can be designed and packed to reduce carryover of liquid with resin material 16 as it is cycled into Position 5. In some embodiments, the bed can be drained in conjunction with the shift to Position 5. In other embodiments the connection 125 can be opened during the initial time after to allow bulk fluid to be returned to Position 6 before connection P-115 is opened. This concept is sub-switching.

At the same time that feed material 21 is introduced into Position 6 a reactive feed comprising monohydric alcohol or a mixture comprising monohydric alcohol and a catalyst, such as an acid or more preferably a strong acid, 23 is introduced into the beginning of the CRB process [of the system at Position 2 through connection P-102. The temperature of the reactive feed mixture 23 can be adjusted to adjust the reaction rate, equilibrium, yield or operability, such as by operating at increased temperature, decreased temperature or with different temperatures within different beds. The beds can include heat transfer capabilities and/or heat transfer equipment can be incorporated between bed stages, as desired. In some embodiments, when a bed is first placed in Position 5, the liquid contents including triacylglycerides can be purged from the bed with reactive feed material from the bed in Position 4, and directed to bed in Position 6 or mixed with the feed material for the bed in Position 6. Once the triacylglyceride containing material is purged from the bed at Position 5, the liquid exiting the bed in Position 5 can be routed to the normal exit P-115 for collection of the crude fatty acid monohydric alcohol ester stream 24. Timing of theses sub-switching cycles can be used to enhance purity and/or recovery efficiency. Various techniques can be utilized to determine when to switch from purge to collection, such as those based on volume of liquid purge, timing, or measurement of the presence or absence of a particular property or compound, such as pH or chemical potential. The fluid connection P-125 shown in FIG. 1 is used for this sub-switching cycle.

The reactive mixture 23 flows from Position 2 to Position 3 to Position 4 and to Position 5, through connections P-122, P-123, and P-124. As the reactive mixture 23 interacts with the fatty acids associated with resin 12, 13, 14, and 15, esterification of the fatty acids and the alcohol present in the reactive feed occurs to form fatty acid monohydric alcohol esters. For reaction of fatty acids adsorbed in the acid form, the reaction equation has the form:

R1-OH+R2-COOH→R2-COO—R1+H2O

For reaction of fatty acids adsorbed in the ionized form, such as onto a cationic ion exchange resin, the reaction equation has the form:

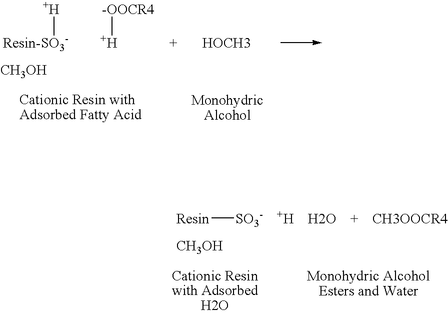

for a strong cationic resin. A similar equation can be used for a weak cationic resin if the reagent solution is an acid alcohol mixture.

This reaction can reduce the polarity and hydrophilicity of the fatty acid as well as eliminate the ionic nature of the fatty acids, facilitating desorption from the resin and allowing the fatty acid monohydric alcohol ester to flow with the reactive feed downstream, which acts as mobile phase, with reduced interaction with the stationary phase through Positions 2, 3, 4, and 5 and out connection P-115 as a stream including fatty acid mono-alkyl ester 24. This stream can be purified downstream by various methods.

In some embodiments, only a portion of the fatty acids associated with the stationary phase are reacted in Position 5 while at least a portion of the remaining fatty acids move to Position 4 during the next sequence step. In Position 4 the mixture of alcohol, acid and fatty acid mono-alkyl esters from Position 3 flow through connection P-123 and into Position 4 where the reaction continues producing more esters. As the sequence continues, the resin in Position 4 moves to Position 3 and to Position 2. By the time the resin material reaches Position 2 and the sequence cycle is about to change much of the fatty acids have reacted and been desorbed from the resin. As a result just before the bed in Position 2 is about to sequence to Position 1 the fluid in the open pores of the resin 12 is primarily reagent solution which is an alcohol or a mixture of alcohol and acid, potentially with product water from the esterification reaction present in the system absorbed into the resin.

The acid esterification reaction rate can depend, at least in part, on the concentration and accessibility of reactants and products, the catalysts activity, the temperature and the pressure. The number of Positions utilized in the CRB section can be determined based on the reaction rate as well as the desired degree of conversion of fatty acids as well as other factors including the specific fatty acids and alcohols present, the particular stationary phase used, and other characteristics of any other solvents present, as well as other characteristics related to the separation such as adsorption isotherms, mass transfer limitations and reaction kinetics.

The concentration of water present during the reaction, whether as a side product of the esterification reaction or from another source, can affect the reaction rate and equilibrium. In some embodiments, the resin that is used as a stationary phase can adsorb water that is present or generated in the system, resulting in improved rates, selectivity, and/or equilibrium for the reaction. Resins particularly suited to water absorption/adsorption include those based on zeolites or silica, but polymeric resins, including synthetic adsorbents and ion exchange resins can also effectively adsorb volumes of water.

In some embodiments, draining or additional regeneration or conditioning steps can be performed at Position 1 prior to shifting resin to Position 8. For example, an additional rinse stream, or a hotter purge solution stream 25 can be introduced into Position 1 through connection P-101 and exit connection P-111. The rinse stream can force absorbed or adsorbed liquid in the resin material out through connection P-111. One example is the removal of water or other materials present in the resin bed material 11. In some cases, added catalyst, such as acids or bases, can also be added to regenerate the stationary phase before being switched to position 8. In some embodiments, the liquid forced from the resin can be collected or utilized as reactive feed, such as by introducing it to the bed in Position 2 through connection P-102. In various embodiments, the rinse stream can be drained or left in the bed.

Numerous variations on the embodiments described herein are possible, such as utilizing greater or fewer number of bed positions within a system or section of a system, or by dividing the introduction of catalyst and alcohol in a CRB system, such as by adding alcohol at one point, and catalyst at a later point or vice versa. Further, while it is preferable in some circumstances for the feed material comprising triacylglycerides to be free of or relatively free of solvents, in some embodiments suitable solvents can also be included or utilized as part of the separation step, such as a component of the feed stream and/or as a mobile phase through the separation portion of the system or the reactor portion of the system. Suitable solvents include supercritical fluids, such as supercritical CO₂, supercritical CO₂ modified with an alcohol, supercritical CO₂ modified with ethanol; hydrocarbons such as hexane, heptane, and others used in the vegetable oil industry; alcohols such as methanol, ethanol, propanol, isopropanol, butanol, etc.

### Additional Processing Steps

In various embodiments, various methods can be utilized to further purify the triacylglyceride material and/or the fatty acid monohydric alcohol esters, or further process them in other ways. Various techniques can be employed, including electrodialysis, extraction, distillation, filtration, crystallization, segregation, neutralization, evaporation, etc. as well as numerous techniques utilized in the edible oils industry.

In one embodiment, an electrodialysis unit can be integrated with the system for purification of the fatty acid mono-alkyl ester. In one version of a suitable system, a feed stream of alcohol, preferably having low water activity, can be fed through the electrodialysis unit as a purge fluid between alternating anionic and cationic charged membranes, while the fatty acid monohydric alcohol ester stream 24 can be fed as a process stream. As an appropriate electrical charge is applied to the electrodialysis unit, the H⁺ ions of the strong acid pass through the anionic charged membranes and into the purge stream and the counter ions of the strong acid pass through the cationic charged membrane into the purge stream and recombine as a strong acid. As the process occurs the strong acid is effectively transferred from the product ester stream 24 into the alcohol purge stream to generate the strong acid, alcohol stream 23 which can be fed into the integrated process 02 or used for some other purpose. Some of the alcohol molecules may pass through the membrane with the ions.

### Examples

The following examples serve to illustrate certain preferred embodiments and aspects and are not to be construed as limiting the scope thereof.

### Example 1

### Adsorption of Fatty Acids from Crude Vegetable Oil Having high Free Fatty Acid Content

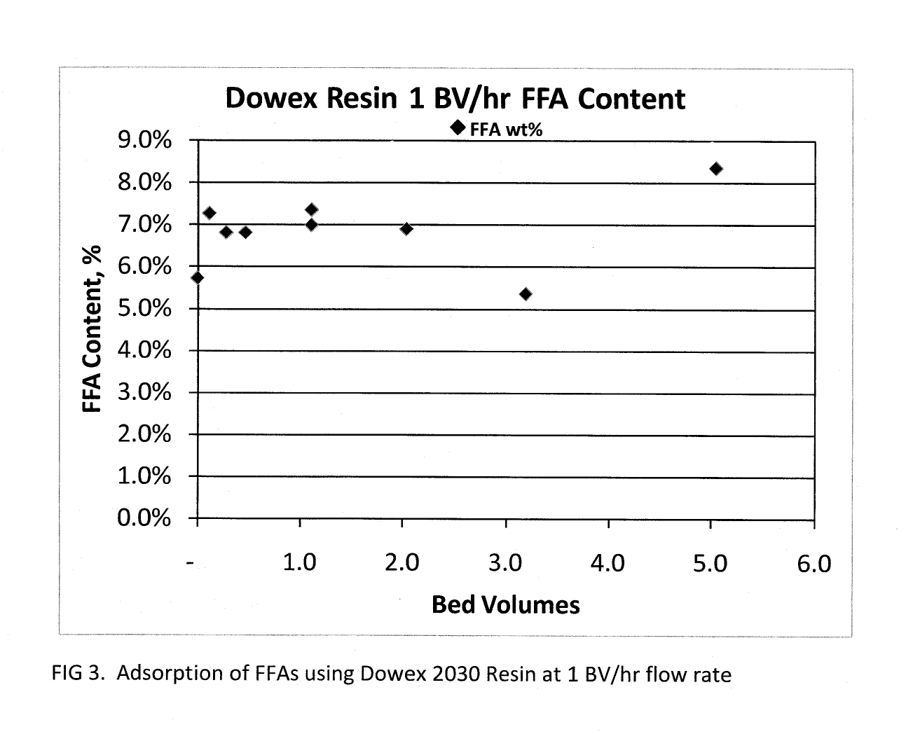

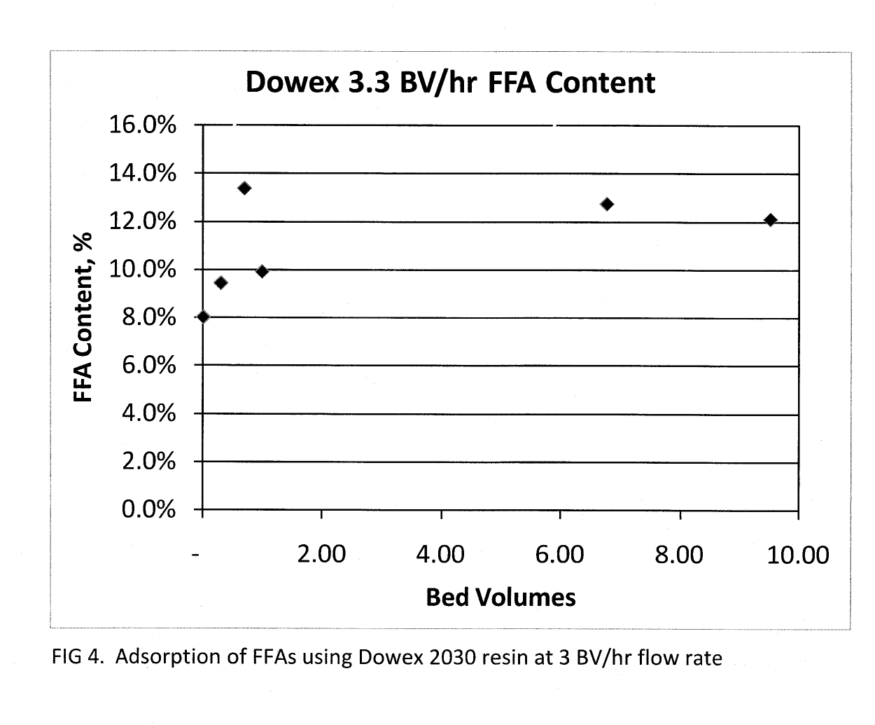

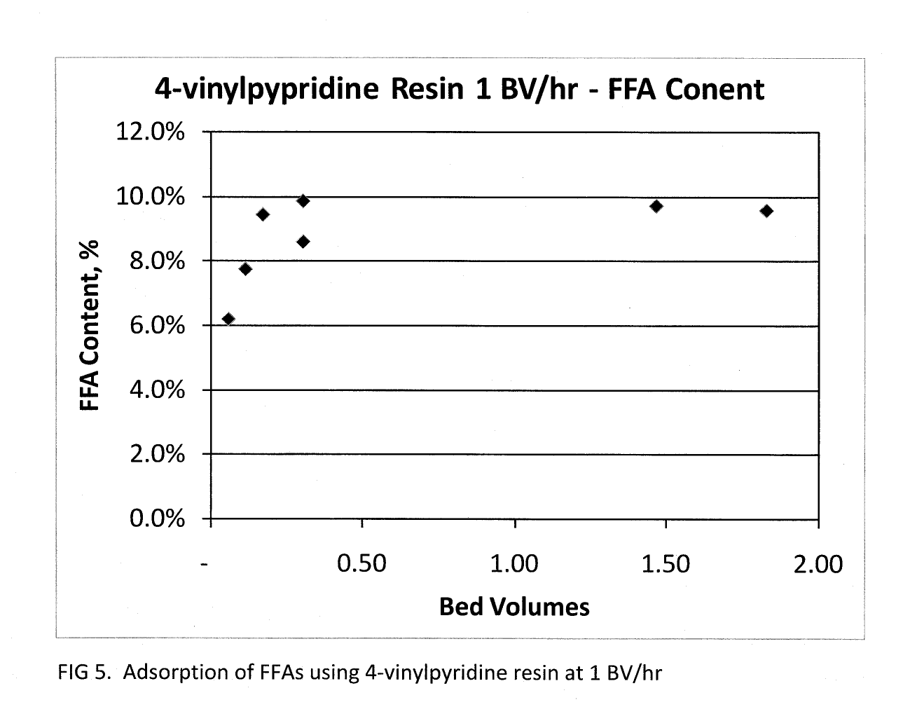

A sample of corn oil was obtained by separation of the thin stillage from a dry grind ethanol facility, having ˜12% (wt.) free fatty acids. After cold filtering, the sample was heated to 80° C. and fed at a rate of 0.3 ml/min or 1 bed volume per minute through a column 7″ long with a ½″ diameter. Various resins can be tested, as shown in Tables 1-4. Samples were taken every over time and analyzed by a Varian gas chromatography system, as described below. Results for Dowex 2030 and a resin utilizing 4-vinylpyridine anionic resin are shown below in FIGS. 3, 4 and 5, which show the concentration of FFA as a function of bed volumes of corn oil eluted. The early rise in concentration eluted up to a value approaching the content of the feed material indicates adsorption of the free fatty acids by all of the resins.

### Lipid Analysis Conditions

The results were verified with a Varian CP-3800 gas chromatograph equipped with a high temperature Factor Four column operating at a temperature gradient of 60 to 380 C, and a mobile phase of helium.

### Example 2

### Adsorption of Fatty Acids from Crude Vegetable Oil Having High Free Fatty Acid Content Using Tertiary Amines

The resin used for this study was immobilized piperidine (Aldrich chemical, catalog #494615). About 0.25 grams of resin was put in a small vial with 0.5 grams of crude cold filtered corn oil. The vials were sealed and placed in a hot water bath that was regulated between 80-85° C. for 4 hours. The results are shown in Table 5.

TABLE 5

| | FFA (wt. %) | FAEE (wt. %) |
|---|---|---|
| cold filtered oil | 9.45% | 0.89% |
| piperidine | 0.80% | 0.97% |

### Example 3

### Demonstration of FFA Conversion into Ethyl Esters Using Acid Catalyst

Tests for conversion of FFA-s into ethyl esters were carried out in batch. About 0.25 grams of a resin was put in a small vial with 0.5 grams of crude cold filtered corn oil. The vials were sealed and placed in a hot water bath that was regulated between 80-85° C. for 4 hours. The results for each resin are shown in Table 6.

TABLE 6

| | FFA (wt. %) | FAEE (wt. %) |
|---|---|---|
| cold filtered oil | 9.45% | 0.89% |
| Dowex 2030 | 1.90% | 13.03% |
| GF101 | 2.18% | 11.77% |

All references cited herein, including but not limited to published and unpublished applications, patents, and literature references are incorporated herein by reference in their entirety and are hereby made a part of this specification. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification are to be understood as being modified in all instances by the term “about.” Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention.

What is claimed is:

1. A process for simultaneously producing a purified vegetable oil, and a material rich in mono-alkyl esters, the process comprising:
sequentially contacting a stationary phase with a feedstock comprising a triacylglyceride and a free fatty acid, and a reactant stream comprising monohydric alcohol, wherein a catalyst is present during at least a portion of the contacting of the stationary phase with the monohydric alcohol;
collecting a first stream comprising triacylglyceride depleted of free fatty acids; and
collecting a second stream containing a fatty acid ester of a monohydric alcohol.

2. The process of claim 1, wherein at least a portion of the stationary phase is at least a portion of the catalyst.

3. The process of claim 1, wherein the first stream comprises free fatty acids at a concentration of less than about 2% (wt.).

4. The process of claim 1, wherein the first stream comprises free fatty acids at a concentration of less than about 0.3% (wt.).

5. The process of claim 1, wherein the second stream comprises fatty acid monoesters at a first weight concentration and free fatty acids at a second weight concentration, the first concentration being greater than the second concentration.

6. The process of claim 1, wherein the first stream comprises free fatty acids at a third weight concentration, and the triacylglyceride feedstock comprises free fatty acids at a fourth weight concentration, the third concentration being less than 40% of the fourth concentration.

7. The process of claim 1, wherein the amount of free fatty acids present in the feedstock is present at a first mass, the amount of free fatty acids present in the first stream is present at a second mass, and the amount of free fatty acids present in the second stream is present at a third mass, the first mass being greater than the sum of the second mass and third mass.

8. The process of claim 7, wherein the ratio of the sum of the second mass and third mass to the first mass is less than about 1 to 2.

9. The process of claim 7, wherein the ratio of the sum of the second mass and third mass to the first mass is less than about 1 to 30.

10. The process of claim 1, wherein the stationary phase comprises an ion exchange resin.

11. The process of claim 10, wherein the catalyst is acidic.

12. The process of claim 10, wherein the chromatographic bed comprises a cationic exchange resin.

13. The process of claim 10, wherein the reactant stream further comprises an acid, and ions of free fatty acids are adsorbed to the chromatographic resin during contacting with the feedstock, and are desorbed when contacted with the reactant stream comprising alcohol and acid.

14. The process of claim 13, wherein the acid comprises a mineral acid.

15. The process of claim 1, wherein the stationary phase is present in a simulated moving bed chromatography system.

16. The process of claim 1, wherein the stationary phase comprises a reverse phase stationary phase that has larger affinity with respect to the triglycerides as compared to one or more of the materials in the feedstock.

17. The process of claim 16, wherein the feedstock further comprises homogenous catalyst with excess alcohol.

18. A system for simultaneously producing a purified vegetable oil, and a material rich in fatty acid monohydrate alcohol esters from an animal or vegetable fat/oil, the system comprising:
a separation bed system having a first zone and a second zone, wherein the first zone utilizes an adsorption process, configured to separate a fatty acid from an triacylglyceride, and the second zone utilizes a combined desorption-reaction process, configured to catalytically convert at least a portion of the fatty acid present into a fatty acid monohydric alcohol ester.

19. The system of claim 18, wherein the separation bed system comprises a simulated moving bed chromatography system.

20. The system of claim 18, wherein the separation bed system comprises a strongly acidic cationic exchange resin.
